(19) United States
(12) Patent Application Publication
(10) Pub. No.: US 2014/0010566 A1
(43) Pub. Date: Jan. 9, 2014

(54) IMAGE PROCESSING APPARATUS, POWER SAVE CONTROL METHOD, AND NON-TRANSITORY RECORDING MEDIUM STORING POWER SAVE CONTROL PROGRAM

(71) Applicants: Rina TAKAHASHI, Kanagawa (JP); Yohsuke UTOH, Kanagawa (JP)

(72) Inventors: Rina TAKAHASHI, Kanagawa (JP); Yohsuke UTOH, Kanagawa (JP)

(73) Assignee: RICOH COMPANY, LTD., Tokyo (JP)

(21) Appl. No.: 13/916,632

(22) Filed: Jun. 13, 2013

(30) Foreign Application Priority Data
Jul. 3, 2012 (JP) 2012-149049

(51) Int. Cl. G03G 15/00

(52) U.S. Cl. CPC G03G 15/80
USPC 399/88

(57) ABSTRACT

An image processing apparatus, a method of controlling a power save state of the image processing apparatus, and a non-transitory recording medium storing a power save control program are provided. In response to detection of a power save transition factor that triggers transition to a power save state, the image processing apparatus determines whether a power save extension factor is detected, extends transition to the power save state at least during when the power save extension factor is being detected, and causes transition to the power save state according to the detected power save transition factor when the power save extension factor is not detected.

### CROSS-REFERENCE TO RELATED APPLICATIONS

This patent application is based on and claims priority pursuant to 35 U.S.C. §119 to Japanese Patent Application No. 2012-149049, filed on Jul. 3, 2012, in the Japan Patent Office, the entire disclosure of which is hereby incorporated by reference herein.

### BACKGROUND

1. Field

The present invention relates to an image processing apparatus, a method of controlling a power save state of the image processing apparatus, and a non-transitory recording medium storing a power save control program.

2. Description of the Related Art

With the increased needs for energy conservation, the image processing apparatuses such as printers, multifunctional peripherals (MFPs), facsimiles, copiers, and computers, are capable of operating in a power save mode. In the power save mode, electric power supply is reduced, or electric power supply supplied to a selected portion of the apparatus is shut down. In response to detection of a predetermined factor, the image processing apparatus is again switched to the waiting state to be ready for operation, while being supplied with electric power supply. For example, the image processing apparatus is switched to operate in the power save mode according to information reflecting the work of a user, such as when a predetermined time period elapses while the image processing apparatus is in a waiting mode, when a current time value reaches a previously set value, or when the level of light from surroundings is lowered below a predetermined level. This may sometimes cause the image processing apparatus to automatically switch to the power save mode, even when the image processing apparatus is being operated by the user or is receiving a user instruction. Once the image processing apparatus is switched to the power save mode, it would take a long time for the apparatus to switch back to the operation mode to process a user request.

Japanese Patent Application Publication No. 2000-276322-A discloses a method of controlling a printing apparatus that shuts down electric power supply at a predetermined time, while allowing the apparatus to postpone the shut-down time according to a printing request. This printing apparatus does not, however, extend the shut-down time according to user operation to the printing apparatus, such that the user may not be able to perform printing right away in case the printing apparatus is in the process of shutting down.

### SUMMARY

In view of the above, one aspect of the present invention is to provide an apparatus and a method of controlling a power save state of an image processing apparatus, and a non-transitory recording medium storing a power save control program. In response to detection of a power save transition factor that triggers transition to a power save state, the image processing apparatus determines whether a power save extension factor is detected, extends transition to the power save state at least during when the power save extension factor is being detected, and causes transition to the power save state according to the detected power save transition factor when the power save extension factor is not detected.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a hardware structure of an image processing apparatus according to an example embodiment of the present invention;

FIG. 2 is a schematic block diagram illustrating a software configuration of a controller of the image processing apparatus of FIG. 1;

FIG. 3 is a schematic block diagram illustrating functional modules of a system of the controller of the image processing apparatus of FIG. 2, according to an example embodiment of the present invention;

FIG. 4 is a flowchart illustrating operation of controlling transition to a power save state, performed by the image processing apparatus of FIG. 3, according to an example embodiment of the present invention;

FIG. 5 is a flowchart illustrating operation of controlling transition to a power save state including the step of determining whether to cancel transition, performed by the image processing apparatus of FIG. 3, according to an example embodiment of the present invention;

FIG. 6 is a schematic block diagram illustrating functional modules of a system of the controller of the image processing apparatus of FIG. 2, according to an example embodiment of the present invention; and

FIG. 7 is a flowchart illustrating operation of controlling transition to a power save state, according to an example embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

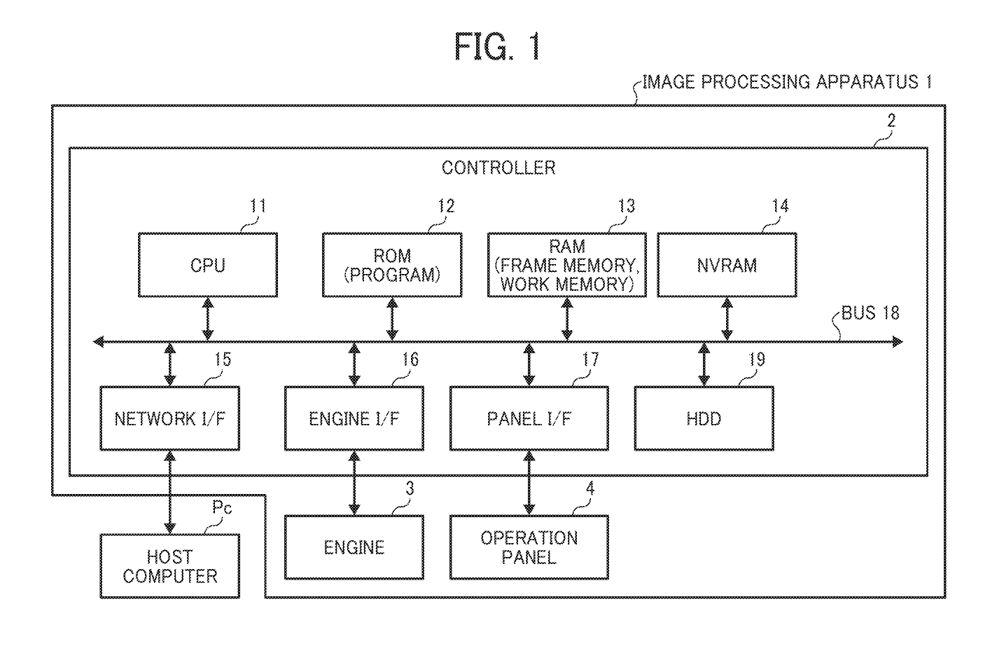

Referring now to FIGS. 1 to 5, an image processing apparatus, a power save control method, and a power save control program are explained according to an example embodiment of the present invention.

The image processing apparatus 1 of FIG. 1 includes a controller 2, an engine 3, and an operation panel 4. The controller 2 includes a central processing unit (CPU) 11, a read only memory (ROM) 12, a random access memory (RAM) 13, a nonvolatile random access memory (NVRAM) 14, a network interface (I/F) 15, an engine I/F 16, a panel I/F 17, and a hard disk drive (HDD) 19, which are connected via a bus 18.

The network I/F 15 connects the image processing apparatus 1 to a communications network such as a local area network (LAN). In this example, a host computer Pc is connected to the communications network, which sends a print request to the image processing apparatus 1 or receives image data from the image processing apparatus 1. The network I/F 15 receives a print job, such as a control signal or data such as print data, from the host computer Pc through the communications network. The network I/F 15 may further send a status signal or image data to the host computer Pc, from the image processing apparatus 1 through the communications network.

The host computer Pc, connected to the network I/F 15, may be implemented by a personal computer having the general-purpose hardware and software structures. For example, the host computer Pc is installed with a print driver capable of generating a print job, which includes print data in a desired page description language (PDL) and a control command (print control data) in a printer job language (PDL). The host computer Pc sends the print job to the image processing apparatus 1. The host computer Pc receives image data, such as document image data read by the image processing apparatus 1, from the image processing apparatus 1.

The ROM 12 stores therein various programs such as programs used by the CPU 11 to process or manage data within the controller 2, or programs used to control peripheral modules. For example, the ROM 12 stores basic processing program designated for the image processing apparatus 1, and power save control program for executing the power save controlling operation. The ROM 12 may further store various data to be used for executing various programs.

The CPU 11 uses the RAM 13 as a work memory to deploy the programs loaded from the ROM 12 onto the RAM 13 to control various parts of the image processing apparatus 1 to perform, such as, printing, scanning, image processing, or controlling power save state transition.

The RAM 13 functions as the work memory of the CPU 11. In one example, the RAM 13 is used as a frame memory that temporarily stores image data by page, such as print data received from the host computer Pc or image data read by a scanner of the engine 3. In another example, the RAM 13 is used as a bitmap memory, in which drawing data being converted from the image data stored in the frame memory and having a form desirable to printing, is deployed. The RAM 13 is a memory with a sufficient memory size, such that the print data, the drawing data converted from the print data, intermediate data, or image data, can be stored for a plurality of pages in the RAM 13.

The NVRAM 14 is a nonvolatile memory, such that data stored in the NVRAM 14 is kept even after the power of the image processing apparatus 1 is turned off. The NVRAM 14 stores various parameter values, which are needed to be kept irrespective of whether the power is turned off, under control of the CPU 11. For example, the NVRAM 14 stores system parameter values, counter values such as the number of printed pages, printing parameter values, and settings information to be used for controlling the power save state.

The engine I/F 16, which is connected to the engine 3, sends various data from the controller 2 to the engine 2, such as a control signal, a status signal, drawing data to be output, or image data being read.

In this example, the engine 3 includes a printer engine and a scanner engine.

The printer engine may be an electrophotographic printer engine, or an inkjet printer engine, depending on the type of the engine 3. As described above, print data received from the host computer Pc at the network I/F 15 is converted to drawing data. According to the drawing data and the control signal via the engine I/F 16, the printer engine of the engine 3 forms an image onto a recording sheet, which is transferred from a sheet feeding device, and outputs the printed image onto an output tray.

More specifically, in case the printer engine of the engine 3 is implemented by the electrophotographic printer engine, the printer engine is provided with various devices that are used to print an image on a recording sheet according to drawing data using the electrophotographic printing method. For example, the printer engine includes one or more image forming units, each or at least one image forming unit including a photoconductor, a charger, an optical writing device, a developing device, a transfer device, and a cleaning device. In case the printer engine is implemented as the color printer engine capable of forming a color image using the electrophotographic printing method, the printer engine includes a plurality of image forming units that respectively correspond to the colors cyan (C), magenta (M), yellow (Y), and black (K). In operation, the printer engine causes the optical writing device to irradiate light based on the drawing data and the control signal, onto a uniformly charged surface of the photoconductor to form an electrostatic latent image. The printer engine further causes the developing device to develop the electrostatic latent image into a toner image with toner. The printer engine further causes the sheet feeding device to feed the recording sheet toward a transfer nip formed between the photoconductor and the transfer device. At the transfer nip, the toner image formed on the photoconductor is transferred onto a recording sheet that is transferred by the transfer device. The recording sheet having the toner image formed thereon is further conveyed to a fixing device. At the fixing device, the toner image is fixed onto the recording sheet by heat and pressure.

In one example, the scanner engine of the engine 3 includes a line image sensor such as a charged coupled device (CCD), an analog/digital (AID) conversion circuit, and a driver circuit that drives various devices. The scanner engine may be further provided with an automatic document feeder (ADF). The ADF may be set with a document set, such as a set of a plurality of pages of document. The ADF feeds the document set, one page by one page, toward a reading position of the scanner engine. The scanner engine scans one page of the document set, fed by the ADF, in the main scanning direction and the sub-scanning direction to generate image data. For example, the scanner reads halftone information from the document to generate image data in a predetermined resolution, such as RGB image data of a predetermined number of bits (such as 8 bits for each color). In alternative to using the CCD, the scanner engine may use a contact image sensor (CIS) or a complementary metal oxide semiconductor (CMOS).

The panel I/F 17 is connected to the operation panel 4 via a universal serial bus (USB) or a serial cable. The panel I/F 17 exchanges a signal between the CPU 11 and the operation panel 4.

The operation panel 4 functions as an operation device that allows the user to input a user instruction. The operation panel 4 is provided with various operation keys such as a ten key, start key, and mode selection key, and a display such as a liquid crystal display with the touch panel function. Through operation of various operation keys or operation of the touch panel of the display, the user is able to input a user instruction such as an instruction for printing or an instruction for controlling electric power consumption. The display of the operation panel 4 displays the user instruction input through the operation keys or the touch panel, and various information such as notification from the image processing apparatus 1 to the user such as various information related to power save control.

The HDD 19 stores various data under control of the CPU 11, such as document image data read by the scanner engine of the engine 3, deployed print data, or print job data received from the host computer Pc. The data stored in the HDD 19 may be read by the other device in the controller 2, under control of the CPU 11.

In this example, the power save control program that causes a processor, such as the CPU 11, to perform power save control method may be stored in any desired computer-readable, non-transitory recording medium. Examples of the recording medium include, but not limited to, ROM, Electrically Erasable and Programmable Read Only Memory (EEPROM), EPROM, flash memory, flexible disk, Compact Disc Read Only Memory (CD-ROM), Compact Disc Rewritable (CD-RW), Digital Video Disk (DVD), Secure Digital (SD) card, and Magneto-Optical Disc (MO). The CPU 11 of the image processing apparatus 1 reads the power save control program stored in the recoding medium onto the RAM 12 or the HDD 19, to cause the image processing apparatus 1 to have the functional modules related to power save control. The power save control program is a computer executable program, which may be written in any language including legacy programming language such as assembler, C, C++, C#, or Java (Trademark), or object oriented programming language. The power save control program may be distributed, for example, in the form of the recording medium or over a network.

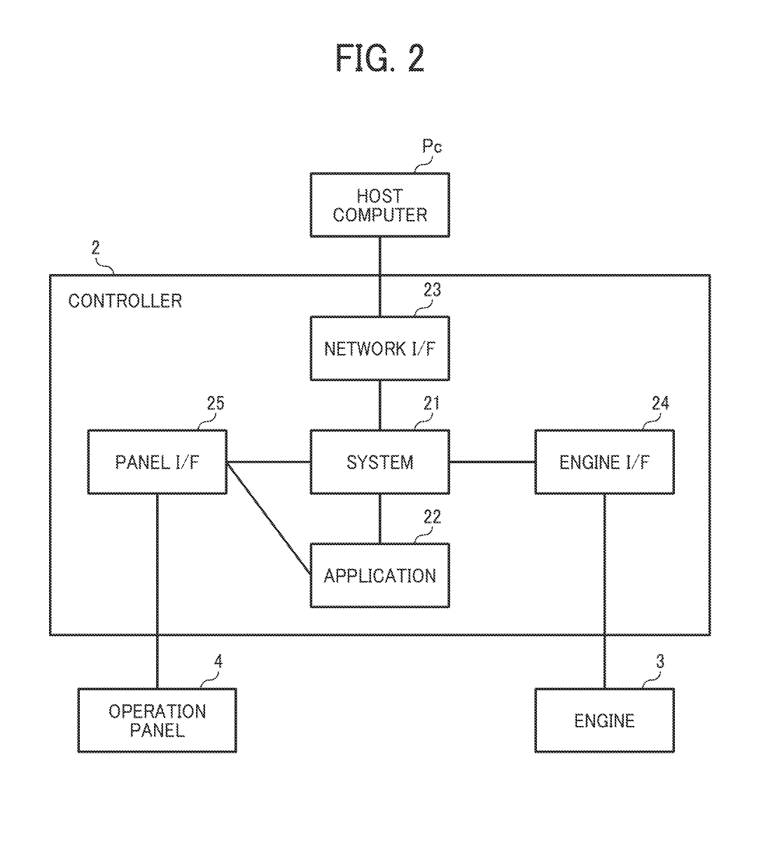

The software programs loaded onto the controller 2 of the image processing apparatus 1 may have a configuration as illustrated in FIG. 2, to cause the controller 2 to have a system 21, application 22, a network I/F 23, an engine I/F 24, and a panel I/F 25.

The system 21 controls entire operation of the image processing apparatus 1. The application 22 operates in cooperation with the system 21 to process various application, such as printing, scanning, and copying.

The network I/F 23 transmits or receives various data such as data or control commands, between the host computer Pc and the system 21. The engine I/F 24 transmits or receives various data such as control commands or data, between the engine 3 and the system 21.

The panel I/F 25 transmits or receives various data, such as signals or data, through the operation panel 4, the system 21, and the application 22.

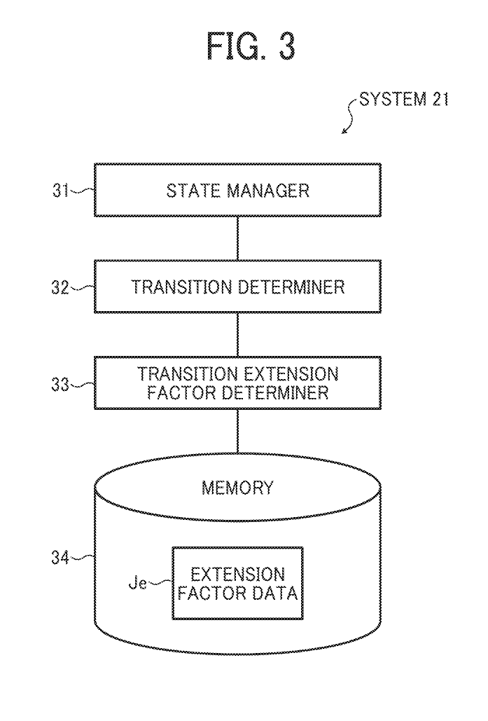

The system 21 of the controller 2 loads the power save control program onto a memory to cause the system 21 to have functional modules of FIG. 3, such as a state manager 31, a transmission determiner 32, a transition extension factor determiner 33, and a memory 34. The memory 34 may be any desired memory such as the RAM 13.

The state manager 31 manages or controls a state of the image processing apparatus 1. In this example, the state manager 31 controls or manages the state of the image processing apparatus 1 that relates to electric power consumption (“electric power state”). Examples of the electronic power state include, but not limited to, the normal operation state such as the normal operation mode, the waiting state such as the sleep or waiting mode, the power save state such as the power save mode, the transition state in which the waiting mode is switched to the power save mode, the transition state in which the power save mode is switched to the waiting mode, and the transition state in which the power save mode is switched to the main power shut-down mode. The state manager 31 may be implemented by the CPU 11 to perform the function of controlling electric power state.

The transition determiner 32 detects whether there is one or more factors (“the power save transition factor”) that may trigger transition to a power save state, which may be previously set, such as a power save mode transition factor, and a main power shut-down mode transition factor. The transition determiner 32 further detects whether there is one or more power save restoration factors that may trigger transition, for example, from the power save mode to the normal operation mode or the waiting mode. For example, when the power save transition factor is detected, the transition determiner 32 notifies the transition extension factor determiner 33 of detection of the power save transition factor. When there is no extension request returned from the transition extension factor determiner 33, the transition determiner 32 outputs a trigger, which instructs the state manager 31 to start the power state transition process according to the detected power save transition factor. The state manager 31 starts transition to the power save state, according to the detected power save transition factor. More specifically, in this example, the transition determiner 32, which may be implemented by the CPU 11, functions as a power save transition factor detector that detects a power save transition factor that triggers transition to a power save mode or a main power shut-down mode. In the power save mode, electric supply to main parts of the image processing apparatus 1 is shut down or decreased, under control of the state manager 31. In the power save shut-down mode, main power supply to the apparatus 1 is shut down. When the power save transition factor is detected, the transition determiner 32 causes the state manager 31 to transition to the power save state according to the detected power save transition factor. When the transition extension factor determiner 33, which functions as the power save extension factor detector, detects the power save extension factor, the transition determiner 32 functions as a power save transition controller that causes the state manager 31 to extend transition to the detected power save state.

Examples of the power save transition factor include, but not limited to, the factor that a predetermined time period elapses after the state is changed to a waiting state in which the image processing apparatus waits for an image processing request while electric power is supplied, the factor that the current time reaches a power save transition time that is previously determined, the factor that the level of light from the surroundings where the image processing apparatus 1 is provided is lowered to a predetermined light level, the factor that no object, such as no human, is detected within a certain area from the image processing apparatus 1. Examples of the power save restoration factor that causes transition from the power save state to the waiting state include, but not limited to, the factor that the operation panel 4 is operated by the user, the factor that a document set is provided on the tray of the scanner engine of the engine 3, and the factor that a specific key such as a restoration key of the operation panel 4 is selected. Examples of the main power shut-down transition factor include, but not limited to, the factor that the current time reaches a main power shut-down transition time that is previously determined, and the factor that the no object, such as no human, is detected within a certain area from the image processing apparatus 1 for a predetermined time period.

The image processing apparatus I is provided with various devices to detect the above-described factors, such as a timer that detects a current time or a time period, a light level sensor that detects the level of light in the surroundings, a sensor that detects an object in the surroundings, and a document sensor that detects a document set provided on the document tray. The detection signal from each of the devices is input to the transition determiner 32, which is implemented by the CPU 11 of the controller 2.

In response to notification from the transition determiner 32 of detection of the power save transition factor, the transition extension factor determiner 33 determines whether an extension factor is detected, which is specified by extension factor data Je stored in the memory 34. When the extension factor is detected, the transition extension factor determiner 33 outputs an extension request to the transition determiner 32 at least for a time period during which the extension factor is being detected. With the extension request, the transition determiner 32 is prevented from outputting the power save state transition trigger to the state manager 31.

The extension factor data Je, previously stored in the memory 34, includes information indicating any desired factor that reflects the state of the image processing apparatus 1 in which electric power supply is desirable to improve operability of the user who may use the image processing apparatus 1 within a predetermined time period counted from the current time. Examples of the extension factor include, but not limited to, the factor that image processing is currently performed on the image processing apparatus 1 such as printing or scanning, the factor that the operation panel 4 is being operated, the factor that an object, such as a human, is detected within a certain area from the image processing apparatus 1, the factor that the level of light in the surroundings exceeds a predetermined level, and the factor that opening of a cover or a door on the body of the image processing apparatus 1 is detected. Any other desired information may be registered as part of the extension factor data Je, which is desirable to prevent the image processing apparatus 1 from making transition to the power save state, for example, to improve operability for the user.

In addition to information indicating the extension factor, the extension factor data Je may further include extension time information indicating an extended time period for each of the extension factors. Based on the extension time data, the transition extension factor determiner 33 may determine an extension time period to be included in the extension request output to the transition determiner 32. For example, when the extension factor indicating operation of the operation panel 4 is detected, it is assumed that the user may input an image processing request through the operation panel 4 such that the extension time period may be set to a longer time period. In another example, when the extension factor indicating printing is detected, it is assumed that the user may not be present at the image processing apparatus 1 such that the extension time period may be set to a shorter time period. With the shorter time period, the transition extension factor determiner 33 can stop outputting the extension request after printing is completed, thus allowing the transition determiner 32 to output the power save state transition trigger to the state manager 31.

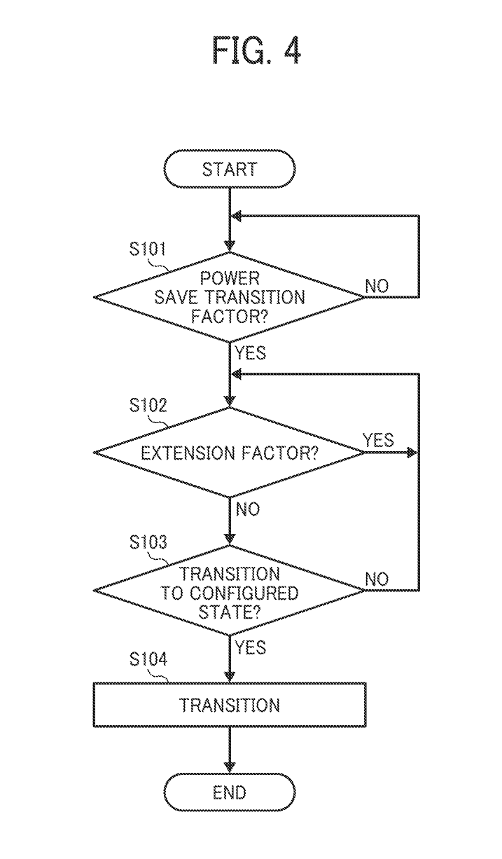

Now, operation of controlling transition to a power save mode in which electric power consumption is reduced, while improving operability, is explained according to an example embodiment of the present invention. More specifically, operation of FIG. 4 is performed by the CPU 11 of the image processing apparatus 1 according to the power save control program.

The state manager 31 monitors the electric power consumption state of the image processing apparatus 1. At S101, the transition determiner 32 detects a power save transition factor, such as a power save mode transition factor or a main power shut-down factor. When the power save transition factor is not detected (“NO” at S101), the operation repeats S101 to detect any power save transition factor, for example, at every predetermined time.

When the power save transition factor is detected (“YES” at S101), at S102, the transition determiner 32 sends notification to the transition extension factor determiner 33 of detection of the power save transition factor, and determines whether a extension request is received from the transition extension factor determiner 33. When the extension request is received (“YES” at S102), the operation repeats S102 to check for the extension factor, for example, at every predetermined time. Thus, S102 is performed until it is determined that the extension request is not received.

In response to the notification from the transition determiner 32 indicating detection of the power save transition factor, the transition extension factor determiner 33 determines whether there is any extension factor as specified by the extension factor data Je stored in the memory 34. When the extension factor is detected, the transition extension factor determiner 33 outputs the extension request to the transition determiner 32, which requests to hold outputting the power save state transition trigger to the state manager 31, at least for a time period during which the extension factor is detected.

At S102, when the extension request is not received from the transition extension factor determiner 33 (“NO” at S102), at S103, the transition determiner 32 determines whether the image processing apparatus 1 is capable of switching to the power save state that is previously set (“configured state”). In this example, the transition determiner 32 may determine whether transition to the power save mode or the main power shut-down mode may be performed. For example, in case the image processing apparatus 1 is currently performing image processing such as printing or scanning, the transition determiner 32 determines that transition to the power save mode or the main power shut-down mode cannot be performed. In such case, the transition determiner 32 waits until image processing is completed, and after completion, determines that transition to the power save state can be performed.

When the transition determiner 32 determines that transition to the power save state that is previously set cannot be performed (“NO” at S103), the operation returns to S102 to repeat S102 and S103.

When the transition determiner 32 determines that transition to the power save state that is previously set can be performed (“YES” at S103), the transition determiner 32 outputs the power save transition trigger to the state manager 31. At S104, with the trigger, the state manager 31 starts transition to the power save state such as the power save mode or the main power shut-down mode, and the operation ends.

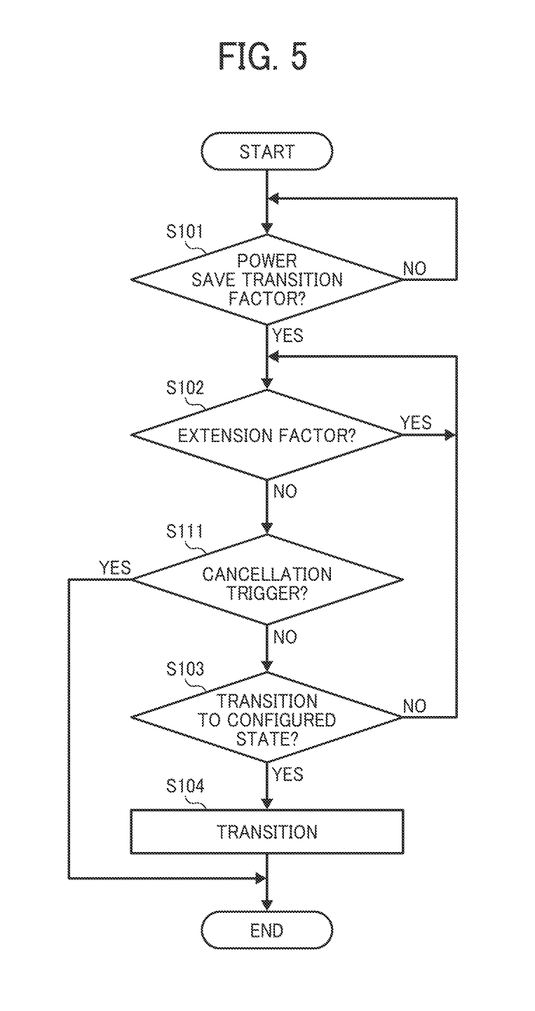

Referring now to FIG. 5, operation of controlling transition to a power save mode in which electric power consumption is reduced, while improving operability, is explained according to an example embodiment of the present invention. The operation of FIG. 5 is substantially similar to the operation of FIG. 4, except for the addition of S111. In this example referring to FIG. 5, while extending output of the power save state transition trigger from the transition determiner 32 to the state manager 31, the transition determiner 32 determines whether there is a cancellation trigger. When the cancellation trigger is detected, the transition determiner 32 stops outputting the power save state transition trigger to the state manager 31, thus, cancelling transition to the power save mode or the main power shut-down mode.

More specifically, referring to FIG. 5, at S101, the transition determiner 32 detects a power save transition factor. When the power save transition factor is detected (“YES” at S101), at S102, the transition determiner 32 sends notification to the transition extension factor determiner 33 of detection of the power save transition factor, and determines whether a extension request is received from the transition extension factor determiner 33.

When the extension factor is received (“YES” at S102), the operation repeats S102 to check for the extension factor, for example, at every predetermined time. Thus, S102 is performed until it is determined that the extension request is not received.

At S102, when the extension request is not received from the transition extension factor determiner 33 (“NO” at S102), at S111, the transition determiner 32 determines whether there is a cancellation trigger (cancellation factor).

The cancellation trigger is generated, while transition to the power save state is being extended due to the extension factor, based on determination that transition to the power save mode or the main power shut-down mode should be cancelled according to intension of the user. For example, the transition extension factor determiner 33 determines that the cancellation trigger is detected, for example, when the current time reaches the power save restoration time that is previously set, or when the power save restoration factor is generated. In this example, the power save restoration time is a time that is previously set to switch from the power save state to the other state such as the waiting state. The power save restoration factor is a factor that triggers transition from the power save state to the other state such as the waiting state.

At S111, when the cancellation trigger is not detected (“NO” at S111), at S103, the transition determiner 32 determines whether the image processing apparatus 1 is capable of switching to the power save state that is previously set (“configured state”), in a substantially similar manner as described above referring to S111 of FIG. 4. When the transition determiner 32 determines that transition to the power save state that is previously set cannot be performed (“NO” at S103), the operation returns to S102 to repeat S102, S111, and S103.

When the transition determiner 32 determines that transition to the power save state that is previously set can be performed (“YES” at S103), the transition determiner 32 outputs the power save transition trigger to the state manager 31. At S104, with the trigger, the state manager 31 starts transition to the power save state such as the power save mode or the main power shut-down mode, and the operation ends.

When the cancellation trigger is detected at Sill (“YES” at S111), the transition determiner 32 determines that transition is cancelled according to intension of the user, and cancels transition to the power save state to end the operation.

As described above, according to one example embodiment of the present invention, the image processing apparatus 1 includes a power controller that controls an electric power state of the image processing apparatus, the electric power state including at least a power save state; a power save transition factor detector configured to detect a power save transition factor that triggers transition to the power save state, the power save state being at least one of a power save mode in which electric power supply to main parts of the image processing apparatus is shut down or reduced, or a main power supply shut-down mode in which main power supply of the image processing apparatus is shut down; a power save extension factor detector configured to detect a power save extension factor for extending transition to the power save state, the power save extension factor being previously determined based on operability of the image processing apparatus for the user; and a power save transition controller configured to, in response to detection of the power save transition factor, determine whether the power save extension factor is detected by the power save extension factor detector, request the power controller to extend transition to the power save state at least during when the power save extension factor is being detected, and cause the power controller to transition to the power save state according to the detected power save transition factor when the power save extension factor is not detected.

For example, the power controller corresponds to the state manager 31. The power save transition factor detector corresponds to the transition determiner 32. The power save extension factor detector corresponds to the transition extension factor determiner 33. The power save transition controller corresponds to the transition determiner 32. The state manager 31, the transition determiner 32, and the transition extension factor determiner 33 may be implemented by a hardware/software combination, such as the CPU 11 executing the power save control program.

With this configuration, in response to detection of the power save transition factor that triggers a request to transition to the power save state such as the power save mode or the main power shut-down mode, the state of the image processing apparatus is changed to the power save mode, thus reducing electric power consumption. Further, in response to detection of the extension factor based on operability of the image processing apparatus 1 for the user, transition to the power save state can be extended. This can reduce electric power consumption, while improving operability for the user.

According to another aspect of the present invention, the present invention may reside in a method of controlling a power save state of an image processing apparatus. The method includes: monitoring electric power state of the image processing apparatus, the electric power state including at least a power save state; detecting a power save transition factor that triggers transition to the power save state, the power save state including at least one of a power save mode in which electric power supply to main parts of the image processing apparatus is shut down or reduced, or a main power supply shut-down mode in which main power supply of the image processing apparatus is shut down; detecting a power save extension factor for extending transition to the power save state, the power save extension factor being previously determined based on operability of the image processing apparatus for the user; determining whether the power save extension factor is detected, in response to detection of the power save transition factor; extending transition to the power save state at least during when the power save extension factor is being detected; and making transition to the power save state according to the detected power save transition factor when the power save extension factor is not detected.

With this method, in response to detection of the power save transition factor that triggers a request to transition to the power save state such as the power save mode or the main power shut-down mode, the state of the image processing apparatus is changed to the power save mode, thus reducing electric power consumption. Further, in response to detection of the extension factor based on operability of the image processing apparatus 1 for the user, transition to the power save can be extended. This can reduce electric power consumption, while improving operability for the user.

According to another aspect of the present invention, the present invention may reside in a non-transitory recording medium storing a plurality of instructions which, when executed by a processor, cause the processor to perform the above-described control method.

The image processing apparatus may be provided with various detectors to detect various factors.

In one example, the image processing apparatus may be provided with an operation device, such as the operation panel 4, which allows the user to input a user instruction. The power save extension factor detector detects the operation state of the operation device, as the power save extension factor. While the user is operating the operation panel 4, it is most likely that the user inputs another operation request through the operation panel 4. In such case, transition to the power save state can be extended, thus improving operability for the user while reducing electric power consumption.

In another example, the image processing apparatus may be provided with an object detector that detects the presence of an object, such as a human, within a predetermined area surrounding the image processing apparatus. The power save extension factor detector detects a detection result of the object detector, as the power save extension factor. When the user is present at or near the image processing apparatus 1, it is most likely that the user inputs an operation request to the image processing apparatus 1. In such case, transition to the power save state can be extended, thus improving operability for the user while reducing electric power consumption.

In another example, the image processing apparatus may be provided with a light level detector, such as a light level sensor, that detects the level of light in the surroundings of the image processing apparatus. The power save extension factor detector detects a detected light level exceeding a predetermined light level, as the power save extension factor. When the light level is equal to or higher than the predetermined level, it can be assumed that the user is present at least in a location where the image processing apparatus 1 is provided, such that it is most likely that the image processing apparatus 1 be used by the user. Extending transition to the power save mode improves operability for the user while reducing electric power consumption.

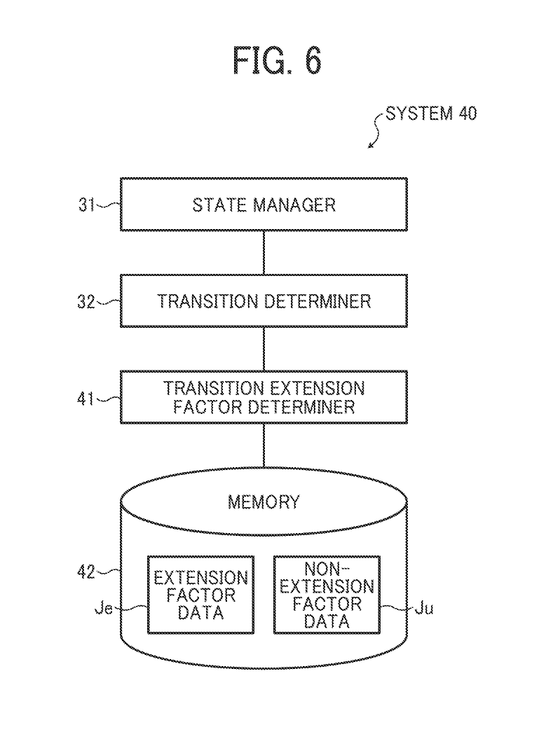

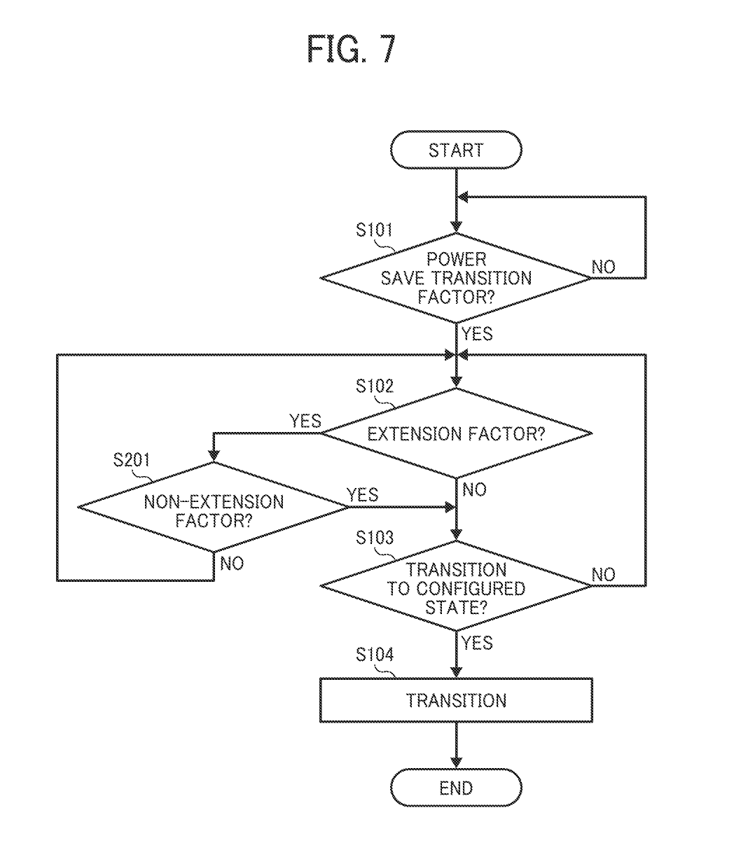

Referring now to FIGS. 6 and 7, an image processing apparatus, a power save control method, and a power save control program are explained according to an example embodiment of the present invention.

FIG. 6 is a schematic block diagram illustrating functional modules of the system of the controller 2 of the image processing apparatus of FIG. 2, according to an example embodiment of the present invention.

The image processing apparatus 1 according to the present embodiment is substantially similar to the image processing apparatus 1 described above referring to FIGS. 1 to 5. In particular, those elements indicated by reference numerals correspond to the elements indicated by the same reference numerals, such that detailed description thereof may be omitted.

Referring to FIG. 6, the system 40 of the image processing apparatus 1 is implemented as a software component deployed on the controller 2, in replace of the system 21. The controller 2 additionally includes the other software components as illustrated in FIG. 2.

The system 40 of the controller 2 loads the power save control program onto a memory to cause the system 40 to have functional modules of FIG. 6, such as the state manager 31, the transition determiner 32, a transition extension factor determiner 41, and a memory 42.

The state manager 31 is substantially similar to the state manager 31 of FIG. 3 in operation and function. The state manager 31 manages or controls the electric power state of the image processing apparatus 1, such as the normal operation state, the waiting state, the transition state in which the waiting state is switched to the power save mode, the power save mode, the transition state in which the power save mode is switched to the waiting state, and the transition state in which the power save mode is switched to the main power shut-down mode.

The transition determiner 32 is substantially similar to the transition determiner 32 of FIG. 3 in operation and function. The transition determiner 32 detects whether there is the power save transition factor, such as the power save mode transition factor or the main power shut-down mode transition factor. When the power save transition factor is detected, the transition determiner 32 notifies the transition extension factor determiner 41 of detection of the power save transition factor. When there is no extension request returned from the transition extension factor determiner 41, the transition determiner 32 outputs a trigger, which instructs the state manager 31 to start the power state transition process according to the detected power save transition factor.

In response to the notification indicating detection of the power save transition factor, from the transition determiner 32, the transition extension factor determiner 41 determines whether the extension factor is detected, which is specified by the extension data Je stored in the memory 42. The transition extension factor determiner 41 further determines whether a non-extension factor is detected, which is specified by non-extension factor data Ju stored in the memory 42. When the extension factor is detected, the transition extension factor determiner 41 outputs an extension request to the transition determiner 32 at least for a time period during which the extension factor is being detected. With the extension request, the transition determiner 32 is prevented from outputting the power save state transition trigger to the state manager 31. When the non-extension factor is detected, the transition extension factor determiner 41 cancels outputting of the extension request to the transition determiner 32.

The extension factor data Je stored in the memory 42 is substantially similar to the extension factor data Je stored in the memory 34 of FIG. 3. Examples of the non-extension factor data Ju include, but not limited to, information indicating that user authentication fails in response to a user authentication request in case the extension factor indicates that the operation panel 4 is being operated by the user, and information indicating that the operation panel 4 is in the “OFF” state.

For example, assuming that the extension factor data Je includes the factor that the operation panel 4 is being operated as the extension factor, and that the non-extension factor data Ju includes the factor that user authentication fails as the non-extension factor, the transition extension factor determiner 41 detects operation to the operation panel 4 as the extension factor, in response to the user authentication process being performed on the operation panel 4. When detected, the transition extension factor determiner 41 postpones the process of outputting the power save state transition trigger. When user authentication fails, the transition extension factor determiner 42 treats the operation to the operation panel 4 as the non-extension factor, and determines that the process of outputting the power save state transition trigger does not have to be postponed. In such case, the transition extension factor determiner 41 cancels outputting the extension request to the transition determiner 32, and causes the state manager 31 to output the power save state transition trigger.

In another example, assuming that the extension factor data Je includes the factor that printing is performed as the extension factor, and that the non-extension factor data Ju includes the factor that turning off of the operation panel 4 as the non-extension factor, the transition extension factor determiner 41 detects printing as the extension factor when the operation panel 4 is kept on. When detected, the transition extension factor determiner 41 postpones the process of outputting the power save state transition trigger. When the operation panel 4 is off, the transition extension factor determines 41 determines that there is no need to extend the process of outputting the power save state transition trigger, as it is not most likely to perform subsequent processing after completion of printing. In such case, when printing is completed, the transition extension factor determiner 41 cancels outputting the extension request to the transition determiner 32, and causes the state manager 31 to output the power save state transition trigger.

Referring now to FIG. 7, operation of controlling transition to a power save mode in which electric power consumption is reduced, while improving operability, is explained according to an example embodiment of the present invention. More specifically, operation of FIG. 7 is performed by the CPU 11 of the image processing apparatus 1 according to the power save control program. The operation of FIG. 7 is performed in a substantially similar manner as described above referring to FIG. 4, except for addition of S201.

At S101, the transition determiner 32 detects a power save transition factor, such as a power save mode transition factor or a main power shut-down factor. When the power save transition factor is detected (“YES” at S101), at S102, the transition determiner 32 sends notification to the transition extension factor determiner 41 of detection of the power save transition factor, and determines whether an extension request is received from the transition extension factor determiner 41.

When the extension factor is received from the transition extension factor determiner 41 (“YES” at S102), at S201, the transition determiner 32 determines whether the extension request becomes invalid due to detection of the non-extension factor. When the extension request is kept valid as there is no non-extension factor being detected (“NO” at S102), the operation repeats S102 to check for the extension factor, for example, at every predetermined time. Thus, S102 and S201 are repeated until it is determined that the extension request is not received or becomes invalid.

More specifically, in response to the notification of detection of the power save transition factor from the transition determiner 32, the transition extension factor determiner 41 determines whether there is any extension factor specified by the extension factor data Je stored in the memory 42 being detected. When the extension factor is detected, the transition extension factor determiner 41 outputs the extension request to the transition determiner 32, which requests to extend the process of outputting the power save state transition trigger to the state manager 31, at least during when the extension factor is being detected. The transition extension factor determiner 41 further determines whether there is any non-extension factor specified by the extension factor data Ju stored in the memory 42 at S201. More specifically, S102 and S201 are repeated to determine whether the non-extension factor is detected at every predetermined time.

At S102, when there is no extension request received from the transition extension factor determiner 41 (“NO” at S102), at S103, the transition determiner 32 determines whether the image processing apparatus 1 is capable of switching to the power save state that is previously set (“configured state”). When the transition determiner 32 determines that transition to the power save state that is previously set cannot be performed (“NO” at S103), the operation returns to S102 to repeat S102, S201, and S103.

When the transition determiner 32 determines that transition to the power save state that is previously set can be performed (“YES” at S103), the transition determiner 32 outputs the power save transition trigger to the state manager 31. At S104, with the trigger, the state manager 31 starts transition to the power save state such as the power save mode or the main power shut-down mode, and the operation ends.

When the extension request is received from the transition extension factor determiner 41 at S102 (“YES” at S102), and when the transition extension factor determiner 41 detects the non-extension factor at S201 (“YES” at S201), the extension request addressed to the transition determiner 32 is made invalid. In such case, at S103, the transition determiner 32 determines that transition to the power save state that is previously set can be performed. When the transition determiner 32 determines that transition to the power save state that is previously set cannot be performed (“NO” at S103), the operation returns to S102 to repeat S102, S201, and S103.

When the transition determiner 32 determines that transition to the power save state that is previously set can be performed (“YES” at S103), the transition determiner 32 outputs the power save transition trigger to the state manager 31. At S104, with the trigger, the state manager 31 starts transition to the power save state such as the power save mode or the main power shut-down mode, and the operation ends.

In alternative to the above-described operation of FIG. 7, while extending output of the power save state transition trigger from the transition determiner 32 to the state manager 31 due to the extension factor, the transition determiner 32 may determine whether there is a cancellation trigger, in a substantially similar manner as described above referring to FIG. 5. When the cancellation trigger is detected, the transition determiner 32 may stop outputting the power save state transition trigger to the state manager 31, thus, cancelling transition to the power save mode or the main power shut-down mode.

As described above, according to one example embodiment of the present invention, the image processing apparatus 1 is provided with a power save extension invalid factor detector that detects a power save extension invalid factor for invalidating the extension of transition to the power save state. For example, the power save extension invalid factor detector corresponds to the transition extension factor determiner 41 capable of detecting a non-extension factor. The non-extension factor is the factor that is previously determined to invalidate the request for extending transition to the power save state, generated based on the extension factor, when such transition does not necessarily contribute to the improved operability of the image processing apparatus 1 for the user. In one example, if invalidation of the extension does not result in the decrease in operability of the image processing apparatus for the user, such factor causing invalidation is determined as the invalid factor.

When the non-extension factor, that is, the power save extension invalid factor, corresponding to the power save extension factor, is detected, the transition extension factor determiner 41 functioning as the power save transition controller invalidates the request for extending transition to the power save state, generated based on the extension factor.

When the extension factor that causes extension of the time to transition to the power save state is invalidated, the image processing apparatus 1 is switched to the power save state. This reduces electric power consumption, while improving operability for the user.

The image processing apparatus 1 may be further provided with a cancellation factor detector that detects a cancellation factor for canceling transition to the power save state. For example, the cancellation factor detector corresponds to the transition extension factor determiner 41 capable of detecting the cancellation trigger, which causes cancellation of transition to the power save state. When the state manager 31 is in the process of transition to the power save state, and when the transition extension factor determiner 41 detects the cancellation factor, the transition determiner 32 cancels transition to the power save state.

When transition to the power save state is extended due to the extension factor, and when the current time reaches the restoration time that is previously set, it is determined that transition to the power save state, such as the power save mode or the main power shut-down mode, is cancelled according to intension of the user in a similar manner as in the case of detecting the power save restoration factor. This reduces electric power consumption, while improving operability for the user.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

Further, any of the above-described devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cashe memory of the CPU, and the RAM may function as a physical memory or a primary memory of the apparatus, while the HDD may function as a secondary memory of the apparatus.

What is claimed is:

1. An image processing apparatus, comprising:
a power controller configured to control an electric power state of the image processing apparatus, the electric power state including at least a power save state;
a power save transition factor detector configured to detect a power save transition factor that triggers transition to the power save state, the power save state being at least one of a power save mode in which electric power supply to main parts of the image processing apparatus is shut down or reduced, or a main power supply shut-down mode in which main power supply is shut down;
a power save extension factor detector configured to detect a power save extension factor for extending transition to the power save state, the power save extension factor being previously determined based on operability of the image processing apparatus for the user; and
a power save transition controller configured to, in response to detection of the power save transition factor, determine whether the power save extension factor is detected by the power save extension factor detector, request the power controller to extend transition to the power save state at least during when the power save extension factor is being detected, and cause the power controller to transition to the power save state according to the detected power save transition factor when the power save extension factor is not detected.

2. The image processing apparatus of claim 1, further comprising:
an operation device configured to receive a user instruction to the image processing apparatus,
wherein the power save extension factor detector detects operation state of the operation device, as the power save extension factor.

3. The image processing apparatus of claim 1, further comprising:
an object detector configured to detect the presence of an object within a predetermined area surrounding the image processing apparatus;
wherein the power save extension factor detector detects a detection result of the object detector, as the power save extension factor.

4. The image processing apparatus of claim 1, further comprising:
a light level detector configured to detect the level of light in the surroundings of the image processing apparatus,
wherein the power save extension factor detector detects a detected light level exceeding a predetermined light level, as the power save extension factor.

5. The image processing apparatus of claim 1, further comprising:
a power save extension invalid factor detector configured to detect a power save extension invalid factor for invalidating the extension of transition to the power save state triggered by the power save extension factor, the power save extension invalid factor being previously determined such that invalidation of the extension does not result in the decrease in operability of the image processing apparatus for the user,
wherein, in response to detection of the power save extension invalid factor that corresponds to the power save extension factor, the power save transition controller cancels extension of transition to the power save state based on the power save extension factor.

6. The image processing apparatus of claim 1, further comprising:
a cancellation factor detector configured to detect a cancellation factor for cancelling transition to the power save state by the power controller,
wherein, in response to detection of the cancellation factor, the power save transition controller cancels transition to the power save state.

7. A method of controlling a power save state of an image processing apparatus, the method comprising:
monitoring electric power state of the image processing apparatus, the electric power state including at least a power save state;
detecting a power save transition factor that triggers transition to the power save state, the power save state including at least one of a power save mode in which electric power supply to main parts of the image processing apparatus is shut down or reduced, or a main power supply shut-down mode in which main power supply of the image processing apparatus is shut down;
detecting a power save extension factor for extending transition to the power save state, the power save extension factor being previously determined based on operability of the image processing apparatus for the user;
determining whether the power save extension factor is detected, in response to detection of the power save transition factor;
extending transition to the power save state at least during when the power save extension factor is being detected; and
causing transition to the power save state according to the detected power save transition factor when the power save extension factor is not detected.

8. A non-transitory recording medium which, when executed by a processor, cause the processor to perform a method of controlling a power save state of an image processing apparatus, the method comprising:
monitoring electric power state of the image processing apparatus, the electric power state including at least a power save state;
detecting a power save transition factor that triggers transition to the power save state, the power save state including at least one of a power save mode in which electric power supply to main parts of the image processing apparatus is shut down or reduced, or a main power supply shut-down mode in which main power supply of the image processing apparatus is shut down;
detecting a power save extension factor for extending transition to the power save state, the power save extension factor being previously determined based on operability of the image processing apparatus for the user;
determining whether the power save extension factor is detected, in response to detection of the power save transition factor;
extending transition to the power save state at least during when the power save extension factor is being detected; and
causing transition to the power save state according to the detected power save transition factor when the power save extension factor is not detected.
